(19) United States
(12) Patent Application Publication
(10) Pub. No.: US 2025/0126196 A1
(43) Pub. Date: Apr. 17, 2025

(54) SECURE CALLER ID

(71) Applicant: T-Mobile USA, Inc., Bellevue, WA (US)

(72) Inventors: Antoine T. Tran, Bellevue, WA (US); Do Kyu Lee, Mercer Island, WA (US)

(21) Appl. No.: 18/488,554

(22) Filed: Oct. 17, 2023

(51) Int. Cl. H04M 3/42

(52) U.S. Cl. CPC H04M 3/42042; H04M 2203/6045

(57) ABSTRACT

Methods and systems for secure caller identification are described herein. In one implementation, when a phone call from a caller is received, a home network may mark a caller ID as trustable in a trusted flag if the caller ID can be verified. The home network may further forward the caller ID and a replica of the flag to a next hop entity until the next hop is the callee. The network on each hop may further verify the caller ID based on a trust relationship between the network and a prior network. In another implementation, the home network of the caller may send a caller ID token (CIT) associated with the caller and send a replica of CIT to a serving network of the callee through one or more networks. The serving network may verify the replica of CIT to determine whether the caller ID is trustable.

### BACKGROUND

In current wireless communication, when a phone call is made or a text message is sent, a caller number is presented to the called party as the caller identification. In some circumstances, a name or a description of the caller is also presented to the called party. The called party and a serving network of the called party may use the information to determine whether to pick up or to forward the phone call or text message. Under various situations, a caller can spoof caller ID, e.g., present a caller ID reserved or assigned to other users. This could cause the caller to steal trust and information from the called party. Particularly, when a phone call gets handed over among different network operators (e.g., mobile network operators, landline network operators, voice over IP operators, etc.), identification of the caller is even more difficult to validate.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example environment, in which secure caller ID is implemented, according to an example of the present disclosure.

FIG. 2 illustrates example chain of trusts, according to an example of the present disclosure.

FIG. 3 illustrates an example process for secure caller ID, according to an example of the present disclosure.

FIG. 4 illustrates an example process for secure caller ID, according to another example of the present disclosure.

FIG. 5 illustrate an example process for secure caller ID, according to yet another example of the present disclosure.

FIG. 6 illustrate an example environment, in which secure caller ID is implemented, according to another example of the present disclosure.

FIG. 7 illustrates an example process for secure caller ID, according to an example of the present disclosure.

FIG. 8 illustrates an example process for secure caller ID, according to another example of the present disclosure.

FIG. 9 illustrates an example computer server that implements techniques for secure caller ID, as described herein.

### DETAILED DESCRIPTION

Techniques for secure caller ID in telecommunications are disclosed herein.

In implementations, a system for securing subscriber identification may comprise a plurality of networks associated with respective network operators. The plurality of networks may pre-establish a trust relationship between each other. Each of the plurality of networks may maintain a list of trusted networks. When a phone call is initiated from a caller to a callee, a chain of trust comprising one or more networks that relay the phone call may be established.

In implementations, the one or more networks may include a telecommunication core network compatible with one or more radio access technologies, wireless access technologies, protocols, and/or standards. For example, wireless and radio access technologies can include fifth generation (5G) technology, Long Term Evolution (LTE)/LTE Advanced technology, other fourth generation (4G) technology, High-Speed Data Packet Access (HSDPA)/Evolved High-Speed Packet Access (HSPA+) technology, Universal Mobile Telecommunications System (UMTS) technology, Global System for Mobile Communications (GSM) technology, WiFi technology, and/or any other previous or future generation of radio access technology. In some examples, the one or more networks may include a landline phone network such as Public Switched Telephone Network (PSTN), Internet that carries voice over IP (VOIP) services, etc. In implementations, the one or more networks may be operated by different network operators and/or different mobile network operators.

In implementations, a telephony application server (TAS) of a home network (e.g., a network that serves the caller) in the chain of trust may verify whether the caller is a registered subscriber based on the caller ID of the caller. When the caller is a verified subscriber, the home network may mark the caller ID as trustable in a verified flag. The TAS of the home network may replicate the verified flag and send the replica of the verified flag along with the incoming call to a next hop network. When the caller cannot be verified (e.g., the caller ID not matching any subscriber ID or the caller purposely hiding the caller ID), the TAS of the home network may generate a status indicating the caller ID is not verified and send the status along with the incoming call to the next hop network.

In some examples, the TAS of the home network may further determine whether the call ID is associated with a potential harmful number or a potential disliked number. If the call ID is associated with a potential harmful number or a potential disliked number, the TAS of the home network may alternatively and/or additionally provide a descriptive string indicating a category that the caller ID falls into (e.g., a potential harmful number or a potential disliked number). The TAS of the home network may send the descriptive string along with the incoming call to the next hop network.

In implementations, the TAS of the home network may maintain a list of potential harmful numbers or potential disliked numbers based on analysis of the incoming phone calls during a period of time. In implementations, the TAS of the home network may analyze the call patterns associated with the incoming phone calls including but are not limited to, call durations, call rejection rate, call no-answering rate, similarity of the area code of the incoming call with the area code of the recipient's phone number (e.g., whether a caller is mimicking a friend or a family member of the callee), call date and time, etc. In some examples, the TAS of the home network may use a machine learning model to learn the patterns of the incoming phone calls.

In implementations, each intermediate network in the chain of trust, upon receiving the replica of the verified flag, may determine whether the adjacent network that forwarding the incoming call is trustable based on its list of trusted networks. If the adjacent network is trustable, the intermediate network may forward the replica of the verified flag to the next hop entity (e.g., a network or callee). If the adjacent network is not trustable, the intermediate network may generate a status indicating the caller ID is not verified and send the status along with the incoming call to the next hop entity.

In some examples, upon receiving an incoming call with a status indicating the caller ID is not verified, the intermediate network may also determine whether the call ID is associated with a potential harmful number or a potential disliked number. The TAS of the intermediate network may be configured to perform similar operations as the TAS of the home network.

As discussed herein, a user generally trusts his/her home network (e.g., the network that the user subscribed to). When the next hop entity is the callee the serving network of the callee is his/her home network, the callee trusts the information transmitted by his/her home network. When the next hop entity is the callee the serving network of the callee is not his/her home network, the user equipment of the callee may further verify whether the serving network is trustable based on its list of trusted network. When the incoming call is received with a verified flag, the caller ID may be presented on an interface of the user equipment of the callee. When the incoming call is received with no verified flag, with a status indicating the caller ID is not verified, or with a descriptive string indicating the caller ID is a potential harmful number or a potential disliked number, a notification showing the status or the descriptive string may be presented on the interface of the user equipment of the callee.

By using an end to end chain of trust between the caller and the callee, the caller ID associated with an incoming call is verified by each network on the chain of trust. When a network cannot trust a prior network, the end to end chain of trust is broken, causing the caller ID cannot be verified. A notification about the unverified caller ID may then be sent to the callee along with the caller ID. By implementing a verified flag and a hop by hop check on the trust relationship, the chain of trust scheme can alert the callee about a suspicious phone call effectively.

In some example, an end node trust model may be used to further protect the caller's identification. In implementations, an additional identification of the caller, a caller identification token (CIT), may be transmitted through the networks in the chain of trust. When a phone call is initiated from a caller to a callee, the TAS of the home network in the chain of trust may retrieve the CIT data associated with the caller based on the phone number from a database storing information associated with registered subscribers. The TAS of the home network may replicate the CIT data and send a replica of the CIT data, through one or more intermediate networks, to a serving network of the callee. The TAS of the serving network of the callee, upon receiving the replica of the CIT data, may determine whether the replica of the CIT data is verified.

In some examples, the CIT data of the subscribers may be registered through a mobile network operator when a subscription of the caller is activated. The CIT data in the database storing information associated with registered subscribers may be accessible to the networks in the chain of trust. In some examples, a Replay Protection Memory Block (RPMB) scheme may be implemented to store the CIT data in the database.

In some examples, the TAS of the home network of the caller may further encrypt the CIT data of the caller using a key pair such as asymmetric keys. Upon receiving the replica of the CIT data, the TAS of the serving network of the callee may decrypt the replica of the CIT data using the same key pair and recover the CIT data.

According to the end node trust model, the caller identity token (CIT) generated at the home network of the caller is only verified at an end node in the chain of trust (e.g., the serving network of the callee), thus, alleviating the process burden on the intermediate networks. In implementations, the CIT-based caller ID protection could be implemented along with the chain of trust caller ID protection to achieve more secured caller ID protection.

The techniques discussed herein may be implemented in a computer network using one or more of protocols including but are not limited to Ethernet, 3^{rd} generation (3G), 4G, long term evolution (LTE), 5G, 6^{th} generation (6G), the further radio access technologies, or any combination thereof. In some examples, the network implementations may support standalone architectures, non-standalone architectures, dual connectivity, carrier aggregation, etc. Example implementations are provided below with reference to the following figures.

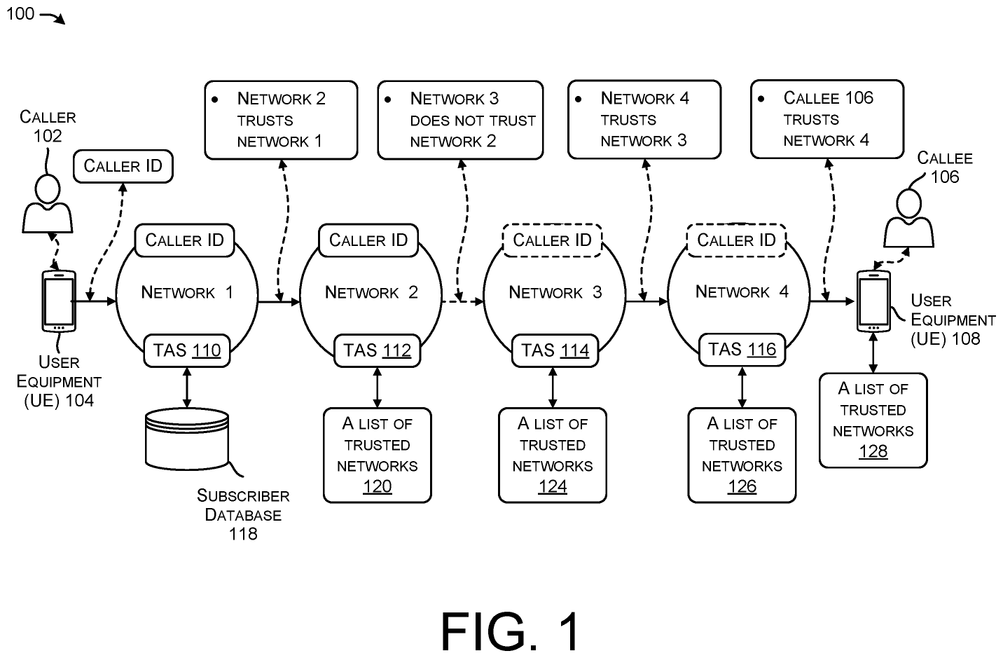

FIG. 1 illustrates an example environment, in which secure caller ID is implemented, according to an example of the present disclosure.

As illustrated, environment 100 may include user equipment (UE) 104 associated with caller 102 and UE 108 associated with callee 106. A communication (e.g., a telephone call, a text message, a multimedia message, etc.) between caller 102 and callee 106 may be established over a plurality of networks such as, network 1, network 2, network 3, and network 4.

The terms of “user equipment (UE),” “user device,” “wireless communication device,” “wireless device,” “communication device,” “mobile device,” and “client device,” can be used interchangeably to describe any UE (e.g., UE 104 and/or UE 108) that is capable of transmitting/receiving data wirelessly using any suitable wireless communications/data technology, protocol, or standard, such as Global System for Mobile communications (GSM), Time Division Multiple Access (TDMA), Universal Mobile Telecommunications System (UMTS), Evolution-Data Optimized (EVDO), Long Term Evolution (LTE), Advanced LTE (LTE+), New Radio (NR), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VOIP), VOLTE, Institute of Electrical and Electronics Engineers' (IEEE) 802.1x protocols, WiMAX, Wi-Fi, Data Over Cable Service Interface Specification (DOCSIS), digital subscriber line (DSL), CBRS, and/or any future Internet Protocol (IP)-based network technology or evolution of an existing IP-based network technology.

Examples of UEs (e.g., UE 104 and/or UE 108) can include, but are not limited to, smart phones, mobile phones, cell phones, tablet computers, portable computers, laptop computers, personal digital assistants (PDAs), electronic book devices, or any other portable electronic devices that can generate, request, receive, transmit, or exchange voice, video, and/or digital data over a network. Additional examples of UEs include, but are not limited to, smart devices such as televisions, refrigerators, washing machines, dryers, smart mirrors, coffee machines, lights, lamps, temperature sensors, leak sensors, water sensors, electricity meters, parking sensors, music players, headphones, or any other electronic appliances that can generate, request, receive, transmit, or exchange voice, video, and/or digital data over a network. Yet additional examples of UEs include, but are not limited to, computing devices associated with vehicles, autonomous vehicles, smart power grid, computing devices associated with industrial automation, computing devices associated with robotics surgery system that can generate, request, receive, transmit, or exchange voice, video, and/or digital data over a network.

Any of UE 104 and UE 108 may be capable of supporting 4G radio communications, such as LTE radio communications, and 5G radio communications, such as New Radio (NR) communications. In some examples, one or more of UE 104 or UE 108 may be configured to support at least one of enhanced Mobile Broadband (eMBB) communications, Ultra Reliable Low Latency Communications (URLLCs), or massive Machine Type Communications (mMTCs). In some instances, the one or more devices can include at least one device supporting one or more of a sensor network, voice services, smart city cameras, gigabytes-in-a-second communications, 3D video, 4K screens, work & play in the cloud, augmented reality, industrial and/or vehicular automation, mission critical broadband, or self-driving cars.

In implementations, the network (e.g., network 1, network 2, network 3, and network 4) may include a telecommunication core network compatible with one or more radio access technologies, wireless access technologies, protocols, and/or standards. For example, wireless and radio access technologies can include fifth generation (5G) technology, Long Term Evolution (LTE)/LTE Advanced technology, other fourth generation (4G) technology, High-Speed Data Packet Access (HSDPA)/Evolved High-Speed Packet Access (HSPA+) technology, Universal Mobile Telecommunications System (UMTS) technology, Global System for Mobile Communications (GSM) technology, WiFi technology, and/or any other previous or future generation of radio access technology. In some other implementations, the network (e.g., network 1, network 2, network 3, and network 4) may include a landline phone network such as Public Switched Telephone Network (PSTN), Internet that carries voice over IP (VOIP) services, etc. In implementations, network 1, network 2, network 3, and network 4 may be operated by different network operators and/or different mobile network operators (MNO). UE can roam from its own network to another MNO's network.

A caller ID associated with caller 102 may be handed over by network 1, network 2, network 3, and network 4 to callee 106. In implementations, each of the plurality of networks may comprise a telephony application server (TAS) configured to provide telephony applications and additional multimedia functions. In some examples, TAS acts as a back-to-back session initiation protocol (SIP) user agent in IMS that maintains the call state. TAS may be configured with service logic that provides basic call processing services such as, digit analysis, routing, call setup, call waiting, call forwarding, caller ID, conferencing, etc. As illustrated in FIG. 1, network 1 may comprise TAS 110, network 2 may comprise TAS 112, network 3 may comprise TAS 114, and network 4 may comprise TAS 116. The functionality of TAS 110, TAS 112, TAS 114, and TAS 116 may vary depending on the network it is associated with. For example, a TAS of the PSTN may provide services such as, caller ID, origination-denial, termination-denial, call forwarding, etc. In some examples, a TAS of a wireless communication network may also provide services such as lettering and coloring so that users can communicate in a richer environment. Particularly, a TAS of a 5G core network, LTE network or LTE/4G network may be implemented in an IP Multimedia Subsystem (IMS) core architecture to further provide services for voice over LTE (VOLTE), voice over WiFi (VoWiFi), voice over 5G (Vo5G) and fixed-access networks.

In implementations, caller 102, callee 106 and the plurality of networks (e.g., network 1, network 2, network 3, and network 4) that connect caller 102 and callee 106 may form a chain of trust. Each network in the chain of trust, in addition to its own subscriber database, may maintain a list of trusted networks. For example, network 2 may maintain a list of trusted networks 120, network 3 may maintain a list of trusted networks 124, and network 4 may maintain a list of trusted networks 126. In general, a user equipment always trusts its home network (i.e., user associated with the UE being a registered subscriber of the network). However, a user equipment may also maintain a list of trusted networks. As illustrated in FIG. 1, if network 1 is a home network of caller 102, UE 104 always trusts network 1. If network 4 is not a home network of callee 106, UE 108 may refer to a list of trusted networks 128 when an incoming call is received.

As illustrated in FIG. 1, when a communication is initiated by caller 102, a caller ID is transmitted to its serving network (e.g., network 1). The caller ID may include a phone number of caller 102, a name of caller 102, or a brief description if caller 102 is a business entity. In some examples, a Mobile Station International Subscriber Directory Number (MSISDN) may be used to represent the caller ID. When the caller is its own subscriber, that is, the serving network is the home network, TAS of the serving network (e.g., TAS 110 of network 1) may check its subscriber database (e.g., subscriber database 118) to determine whether the caller ID matches a registered subscriber ID. In the example as shown in FIG. 1, the caller ID matches a registered subscriber ID, and TAS 110 of network 1 marks the caller ID as trustable in a flag (also referred to as trusted flag or verified flag). Network 1 may further forward the phone call, the caller ID, and the flag to network 2. Upon receiving the incoming call, network 2 may determine that network 1 is in the list of trusted network 124 and forward the phone call, the caller ID, and a replica of the flag to the next hop network in the chain (e.g., network 3). As network 2 is not a trusted network, network 3 may generates a status indicator indicating the caller ID cannot be verified. The network 3 then forwards the phone call, the caller ID, and the status indicator to the next adjacent network in the chain (e.g., network 4). Although network 4 trusts network 3, because the chain of trust is broken between network 2 and network 3, network 4 may forward the phone call, the caller ID, and the status indicator to UE 108.

In some examples, when a caller ID cannot be verified, the TAS of any of network 1, network 2, network 3, and network 4 may further determine whether the call ID is associated with a potential harmful number or a potential disliked number. If the call ID is associated with a potential harmful number or a potential disliked number, the TAS of the network may alternatively and/or additionally provide a descriptive string indicating a category that the caller ID falls into (e.g., a potential harmful number or a potential disliked number). The descriptive string along with the incoming call may be transmitted to the networks along the chain of trust. In implementations, the TAS may maintain a list of potential harmful numbers or potential disliked numbers based on analysis of the incoming phone calls during a period of time. In implementations, the TAS may analyze the call patterns associated with the incoming phone calls including but are not limited to, call durations, call rejection rate, call no-answering rate, similarity of the area code of the incoming call with the area code of the recipient's phone number (e.g., whether a caller is mimicking a friend or a family member of the callee), call date and time, etc. In some examples, the TAS may use a machine learning model to learn the patterns of the incoming phone calls. Technical details of determining whether an incoming call is associated with a potential harmful number or a potential disliked number are disclosed in a related patent application U.S. application Ser. No. 18/195,302, titled “DETECTION AND ALERT LOGIC BY CLOUD DATA FOR A POTENTIAL HARMFUL OR DISLIKE NUMBER.”

As discussed herein, by building an end to end chain of trust between the caller and the callee based on hop by hop trust relationship between adjacent networks, the caller ID associated with an incoming call is checked by the network on each hop. When a trust cannot be established between UE and its serving network or between adjacent networks, the end to end chain of trust is broken, causing the caller ID cannot be verified. A notification about the unverified caller ID may then be sent to the callee along with the phone call. The end to end chain of trust schemed can alert the callee about a suspicious phone call more securely and effectively by implementing a hop by hop trust scrutinization.

It should be appreciated that example environment 100 is for illustration purposes. The present disclosure is not intended to be limiting. Rather than being a serving network of caller 102, network 1 can be an intermediate network in the chain of trust. Under that circumstance, network 1 also maintains a list of trusted network. Further, any of network 2, network 3, and network 4 may serve as a home network of an incoming call, and thus, each of network 2, network 3, and network 4 could also maintain its own subscriber database. Even further, depending on the locations of the caller and the callee, the chain of trust may comprise any number of networks.

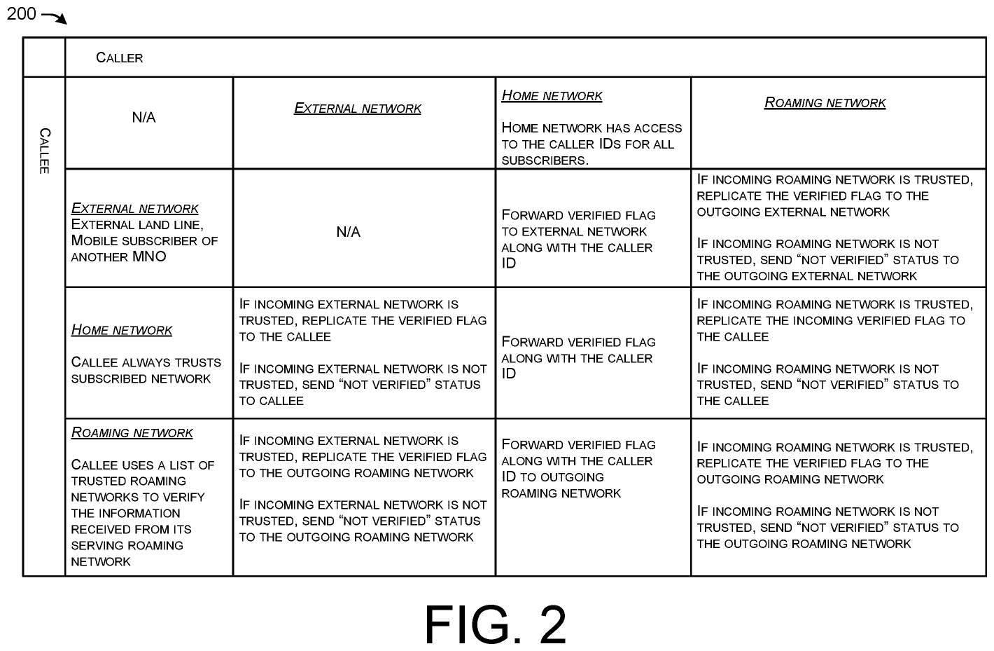

FIG. 2 illustrates example chain of trusts, according to an example of the present disclosure.

Example chain of trust 200 illustrates the actions that the network may take depending on its role in the chain of trust. The role of a network may be a home network, an external network, or a roaming network. A home network may be referred to as a subscribed network where a caller subscribes services through. As discussed herein, a callee may always trust his/her home network. An external network may be referred to as an external landline network or a mobile network operated by another mobile network operator (MNO) other than the home network operator. A roaming network may be referred to as a network that the callee is connected to, where the network is not a home network of the callee. The callee may use a list of trusted roaming networks to verify the information received from its serving roaming network.

In some examples, when a callee (e.g., callee 106 of FIG. 1) is connected to its home network and the home network receives an incoming call from an external network, the home network may determine whether the external network is trusted. If the external network is trusted, the home network may replicate the flag (e.g., the trusted flag or the verified flag indicating the caller ID is trustable) and transmit the replica of the flag to the callee. If the external network is not trusted, the home network may send a “not verified” status indicator to the callee.

In some examples, a roaming network may be the next hop network and adjacent to an external network. The roaming network may determine whether the incoming external network is trustable. If the incoming external network is trustable, the roaming network may replicate the flag (e.g., the trusted flag or the verified flag indicating the caller ID is trustable) and transmit the replica of the flag to an outgoing roaming network. If the incoming external network is not trustable, the roaming network may send a “not verified” status indicator to the outgoing roaming network.

As discussed herein, a home network has access to the caller IDs for all its subscribers. The home network may forward verified flag along with the caller ID to an external network, an outgoing roaming network, or a home network of the callee.

In some examples, when an external network is the next hop network and adjacent to a roaming network, the external network may determine whether the incoming roaming network is trustable. If the incoming roaming network is trustable, the external network may replicate the verified flag and send the replica of the verified flag to an outgoing external network. If the incoming roaming network is not trustable, the external network may send a “not verified” status indicator to the outgoing external network.

In some other examples, when a roaming network is a last hop to a home network of the callee, the home network may determine whether the roaming network is trustable. If the roaming network is trustable, the home network of the callee may replicate the verified flag and send the replica of the verified flag to the callee. If the roaming network is not trustable, the home network of the callee may send a “not verified” status indicator to the outgoing external network.

In yet another example, when a roaming network is adjacent to another roaming network in the chain of trust, the roaming network may determine whether the incoming roaming network is trustable. If the incoming roaming network is trustable, the roaming network replicate the verified flag and send the replica of the verified flag to an outgoing roaming network. If the incoming roaming network is not trustable, the roaming network may send a “not verified” status indicator to the outgoing roaming network.

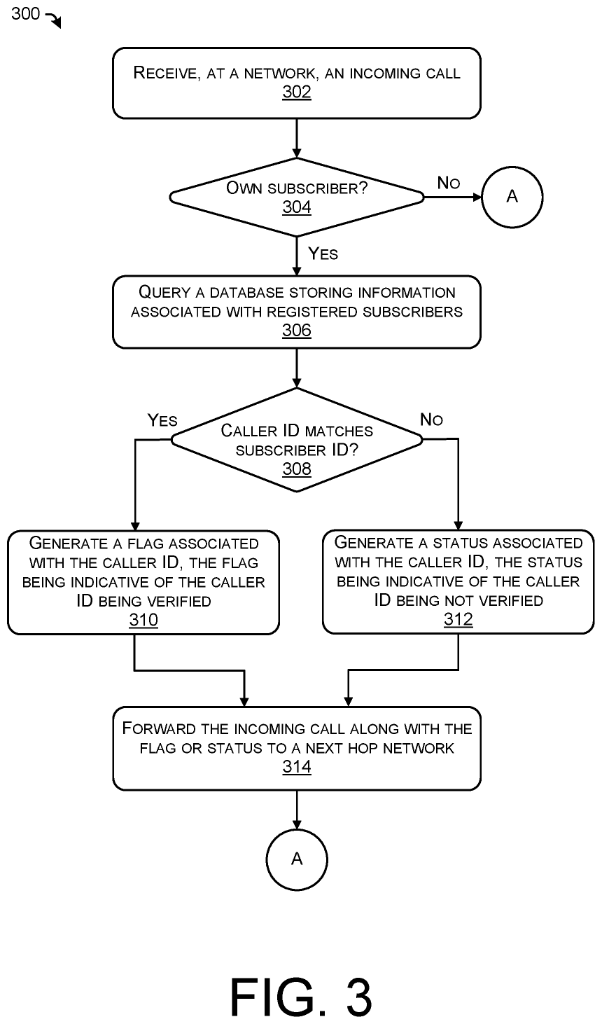

FIG. 3 illustrates an example process for secure caller ID, according to an example of the present disclosure. Example process 300 may be implemented by a telephony application server of a serving network to a caller in a chain of trust (e.g., TAS 110 of network 1, as shown in FIG. 1).

At operation 302, the process may include receiving, at a network, an incoming call. As discussed herein, the incoming call may be initiated from a mobile phone, a landline phone, a VoIP phone, etc. The network may be wireless communication network, a landline network, Internet, etc. The incoming call may also include caller ID information that identifies the caller's identity such as a phone number, a person's name, a business name, etc. For a mobile phone call, the caller ID information may be further associated with an identity of the mobile device the caller is using. For example, the caller ID information may be associated with the SIM card of the mobile device.

At operation 304, the process may include determining whether the incoming call is from its own subscriber. The TAS of the network may determine whether the incoming call is from its own subscriber based on one or more prefix numbers in the phone number.

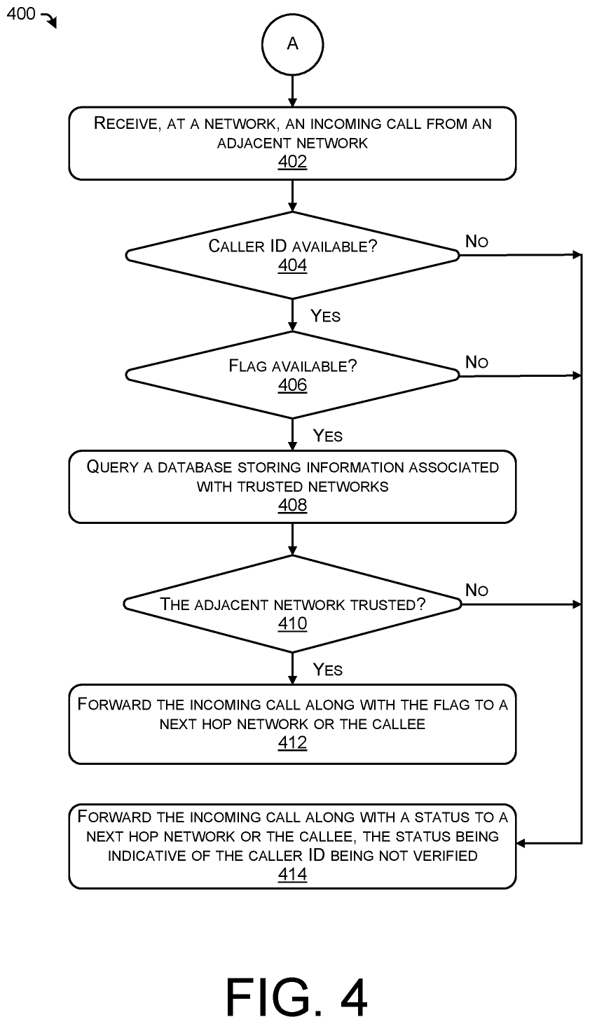

When the incoming call is not from its own subscriber, the TAS of the network may determine that the incoming call is from an adjacent network (e.g., an external network or a roaming network) and handle the incoming call according to example process 400 of FIG. 4.

When the incoming call is from its own subscriber, at operation 306, the process may include querying a database storing information associated with registered subscribers. In some examples, the TAS of the network may compare the phone number of the incoming call with the registered phone number of all its subscribers.

At operation 308, the process may include determining whether the caller ID matches a subscriber ID. When there is a match between the caller ID and the subscriber ID, at operation 310, the process may include generating a flag associated with the caller ID, the flag being indicative of the caller ID being verified. In implementations, the flag may be generated using an internal algorithm of the TAS.

When there is no match between the caller ID and the subscriber ID, at operation 312, the process may include generating a status associated with the caller ID, the status being indicative of the caller ID being not verified. In some examples, the TAS of the home network may further determine whether the caller ID is associated with a potential harmful number or a potential disliked number. The TAS of the home network may alternatively or additionally provide a descriptive string indicating whether the caller ID is associated with a potential harmful number or a potential disliked number.

At operation 314, the process may include forwarding the incoming call with the flag or the status to a next hop network. The subsequent process is described according to example process 400 of FIG. 4.

FIG. 4 illustrates an example process for secure caller ID, according to another example of the present disclosure. Example process 400 describes subsequent process following example process 300 of FIG. 3, and may be implemented by a telephony application server of an intermediate network in the chain of trust (e.g., any of TAS 112 of network 2, TAS 114 of network 3, TAS 116 of network 4, as shown in FIG. 1).

At operation 402, the process may include receiving, at a network, an incoming call from an adjacent network. As discussed herein, the network described herein may be any intermediate network in the call flow from a caller to a callee, except the serving networks or the home networks of the caller and the callee. The network may be wireless communication network, a landline network, Internet, etc.

At operation 404, the process may include determining whether a caller ID is available for the incoming call. In some examples, a caller may choose not to display the caller ID, causing even its home network cannot identify the caller's identity. If the caller ID is not available, the process may continue at operation 414, in which, the process may further include forwarding the incoming call along with a status to a next hop network or the callee, the status being indicative of the caller ID being not available.

If the caller ID is available, at operation 406, the process may include determining whether a flag is available. If the flag is not available, the process continue at operation 414, in which, the process may further include forwarding the incoming call along with a status to a next hop network or the callee, the status being indicative of the caller ID being not verified. In some examples, at operation 414, the process may further include forwarding the incoming call along with a descriptive string indicating whether the caller ID is associated with a potential harmful number or a potential disliked number.

If the flag is available, which indicates the caller ID is trustable, at operation 408, the process may include querying a database storing information associated with trusted networks. In implementations, the database storing information associated with trusted networks may be maintained by a computer device associated with the network. The list of trusted networks may be periodically updated to include the up-to-date trust relationships between the network and other networks.

At operation 410, the process may include determining whether the adjacent network is trusted. As discussed herein, the adjacent network is referred to a network that hands over the phone call from the caller.

If the adjacent network is in the list of trusted network, at operation 412, the process may include forwarding the incoming call along with the flag to a next hop network or the callee.

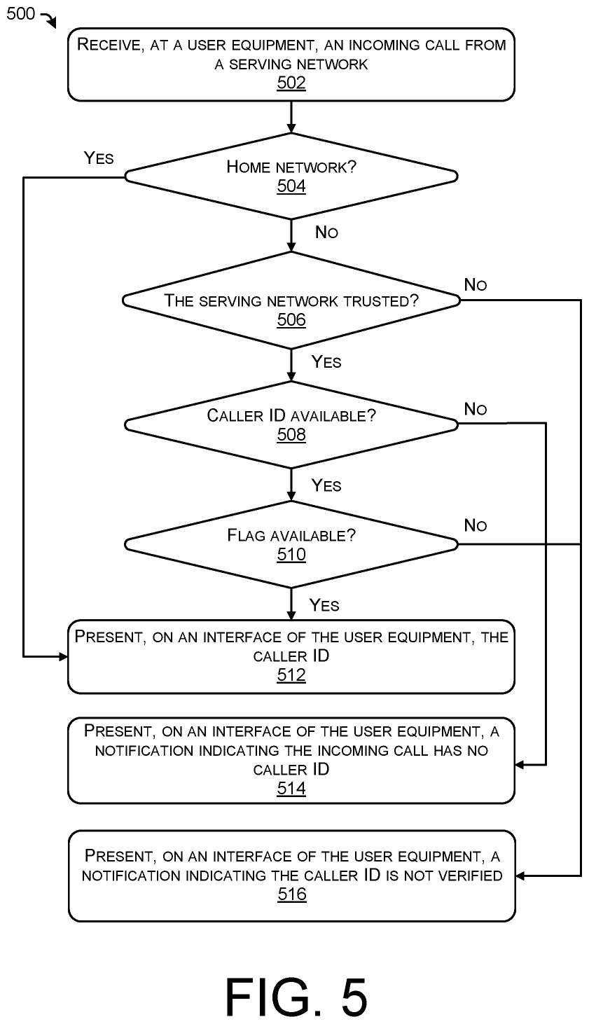

FIG. 5 illustrate an example process for secure caller ID, according to yet another example of the present disclosure. Example process 500 may be implemented by a user equipment associated with a callee (e.g., UE 108 associated with callee 106, as shown in FIG. 1) in the chain of trust.

At operation 502, the process may include receiving, at a user equipment, an incoming call from a serving network. As discussed herein, the serving network of the callee may be a home network of the callee or a roaming network/external network.

At operation 504, the process may include determining whether the serving network is a home network of the callee. As discussed herein, a user may always trust his/her home network. If the serving network is the home network of the callee, the process may continue at operation 512, in which, the process may further include presenting, on an interface of the user equipment, the caller ID.

If the serving network is not the home network of the callee, at operation 506, the process may include determining whether the serving network is trusted. The UE may query a database or a memory for a list of trusted networks and determine whether there is a match between the serving network and a trusted network.

If the serving network is trusted, at operation 508, the process may include determining whether a caller ID is available. If the caller ID is not available, the process may continue at operation 514, in which, the process may include presenting, on an interface of the user equipment, a notification indicating the incoming call has no caller ID.

If the caller ID is available, at operation 510, the process may include determining whether a flag is available. In some examples, the flag may be a replica of a flag (e.g., a trusted flag, or a verified flag) generated by the home network/serving network of the caller to indicate the caller ID is trustable.

If the flag is not available, the process may continue at operation 516, in which, the process may include presenting, on an interface of the user equipment, a notification indicating the caller ID is not verified. In some examples, at operation 516, the process may further include presenting, on the interface of the user equipment, a descriptive string indicating whether the caller ID is associated with a potential harmful number or a potential disliked number.

If the flag is available, at operation 514, the process may include presenting, on an interface of the user equipment, the caller ID.

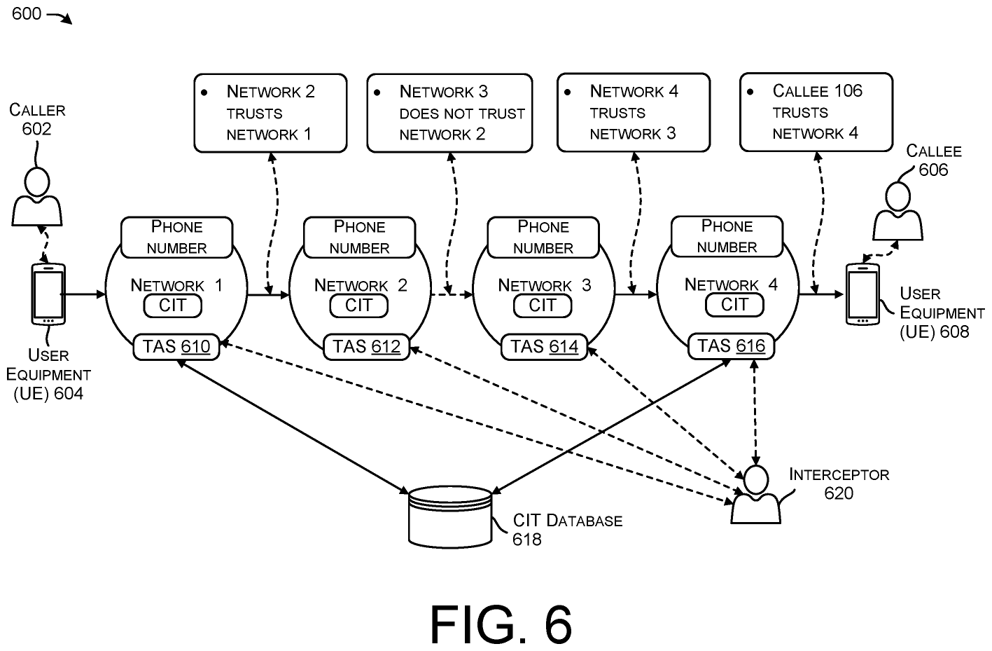

FIG. 6 illustrate an example environment, in which secure caller ID is implemented, according to another example of the present disclosure.

As illustrated, example environment 600 may include user equipment (UE) 604 associated with caller 602 and UE 608 associated with callee 606. A communication (e.g., a telephone call, a text message, a multimedia message, etc.) between caller 602 and callee 606 may be established over a plurality of networks such as, network 1, network 2, network 3, and network 4.

Similar to example environment 100, any of UE 604 and UE 608 may be capable of supporting 4G radio communications, such as LTE radio communications, and 5G radio communications, such as New Radio (NR) communications. Further, the network (e.g., network 1, network 2, network 3, and network 4) may also include a telecommunication core network compatible with one or more radio access technologies, wireless access technologies, protocols, and/or standards. In some other implementations, the network (e.g., network 1, network 2, network 3, and network 4) may include a landline phone network such as PSTN, Internet that carries voice over IP (VOIP) services, etc. In implementations, network 1, network 2, network 3, and network 4 may be operated by different landline network operators and/or different mobile network operators (MNO). In implementations, each of the plurality of networks may comprise a telephony application server (TAS) configured to provide telephony applications and additional multimedia functions. For example, network 1 may comprise TAS 610, network 2 may comprise TAS 612, network 3 may comprise TAS 614, and network 4 may comprise TAS 616.

In some examples, an interceptor 620 may impose an attack between two entities in the chain of trust established between caller 602 and callee 606 such as, between two networks, between UE and its serving network, etc. Interceptor 620 can then monitor, modify, or redirect the data that is exchanged, without the knowledge or consent of caller 602. The term “interceptor” can be used interchangeably to describe any attacker or any man in the middle attack (MIMT) that imposes a cybersecurity issue to a network or a system. As discussed herein, an MSISDN is used to represent the caller ID in existing techniques. Although MSISDN links the subscriber and his/her mobile device to the network, such information may be tampered when the phone call is handed over between networks. In some examples, additional caller identity may be used to further protect and facilitate the identification of the caller.

According to example environment 600, regardless the trust relationships between the plurality of networks, caller ID associated with caller 602 (e.g., a phone number) may be propagated through the plurality of networks (e.g., network 1, network 2, network 3, and network 4) without being verified at each hop of the plurality of networks. A caller identity token or a caller ID token (CIT) associated with caller 602 may be used and propagated through the plurality of networks. When an incoming call is received from UE 604 used by caller 602, the home network (e.g., network 1) may obtain CIT associated with caller 602 from a CIT database 618 based on the caller ID of caller 602 (e.g., phone number). In some examples, CIT may be registered in one or more trusted authorities or MNOs when the subscription of caller 602 is activated. In implementations, TAS of the home network of caller 602 (e.g., TAS 610) may further encrypt CIT data of caller 602 using a key pair such as, asymmetric keys, before sending it to the next hop network (e.g., network 2). In some examples, a Replay Protected Memory Block (RPMB) scheme may be implemented to store CIT data for all subscribers in CIT database 618 for protecting data from a replay attack or avoiding unexpected data updates. Mobile network operators may have access to CIT information stored in CIT database 618. In some examples, CIT database 618 may be located in one or more MNOs' networks and/or clouds.

As illustrated in FIG. 6, encrypted CIT data of caller 602 may be handed over by network 1, network 2, network 3, and network 4 to callee 106. The intermediate networks (e.g., network 2 and network 3) may forward the phone call with associated phone number and CIT without validating the phone number and/or CIT. The serving network of callee 606 (e.g., network 4), upon receiving the incoming call, may query CIT database 618 and determine whether the receiving CIT can be validated. In implementations, TAS of the serving network of callee 606 (e.g., TAS 616) may decrypt the received CIT using the key pair used for encryption (e.g., asymmetric keys) and compare it with stored CIT data associated with caller 602. When there is a match, network 4 may forward the phone call and notify callee 606 that the caller ID of caller 602 is verified. A phone number, a name, or a description of caller 602 may then be presented on an interface of UE 608.

As discussed herein, by implementing a caller identity token (CIT), the present disclosure provides an additional and/or an alternate scheme of caller identity protection for end-to-end phone calls. Comparing to the chain of trust example described with respect to FIGS. 1-5, the caller identity token is only validated at an end node of the chain of trust (e.g., the serving network of the callee), thus, alleviating the process burden on the intermediate networks.

Although the examples illustrated FIG. 1 and FIG. 6 are described separately, it should be understood that the present disclosure is not intended to be limiting. CIT-based caller ID protection could be implemented along with the chain of trust caller ID protection. In some examples, upon receiving a “not verified” caller ID from an incoming network, the serving network of the callee (e.g., network 4 that serves callee 106, as shown in FIG. 1) may still query CIT database 618 (not shown in FIG. 1) and determine whether the received CIT can be validated. If the received CIT can be validated, the serving network of the callee (e.g., network 4 that serves callee 106, as shown in FIG. 1) may update the notification to the callee that the caller ID could be trusted. In some other examples, an intermediate network (e.g., network 3 as shown in FIG. 1) may also query CIT database 618 (not shown in FIG. 1) and determine whether the received CIT can be validated, if the incoming caller ID is noted as “not verified.” If the received CIT can be validated, the intermediate network (e.g., network 3 as shown in FIG. 1) may update the notification to be sent to the next hop network that the caller ID could be trusted. In some examples, the intermediate network may mark the caller ID as trustable in a trusted flag and forward the trusted flag to the next hop network. In some examples, any network in the chain of trust may be configured to further determine whether the caller ID is associated with a potential harmful number or a potential disliked number and provide an alternative/additional protection on the caller ID information.

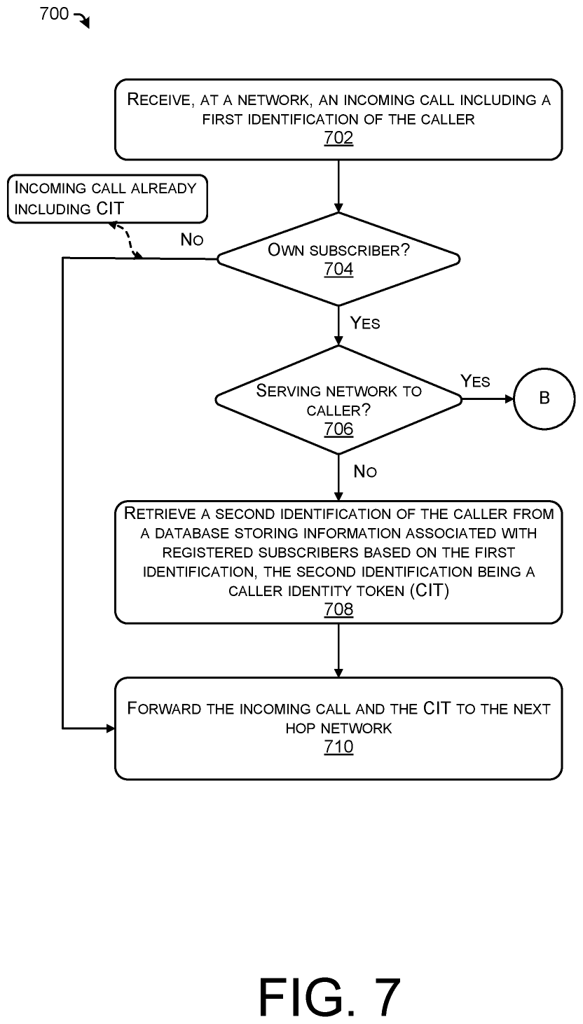

FIG. 7 illustrates an example process for secure caller ID, according to an example of the present disclosure. Example process 700 may be implemented by a telephony application server of a serving network to a caller (e.g., TAS 610 of network 1, as shown in FIG. 6) according to the example described in FIG. 6.

At operation 702, the process may include receiving, at a network, an incoming call including a first identification of the caller. As discussed here in the network may be a wireless communication network a landline network, or an Internet backbone etc. The first identification of the caller may include a phone number of the caller, a name of the caller, a business name of the caller, etc.

At operation 704, the process may include determining whether the incoming call is from its own subscriber. If the incoming call is not from its own subscriber, which means the incoming call is forwarded from an external network or a roaming network and already includes a caller identity token (CIT), the process may continue at operation 710, in which the process may include forwarding the incoming call with the CIT to the next hop network

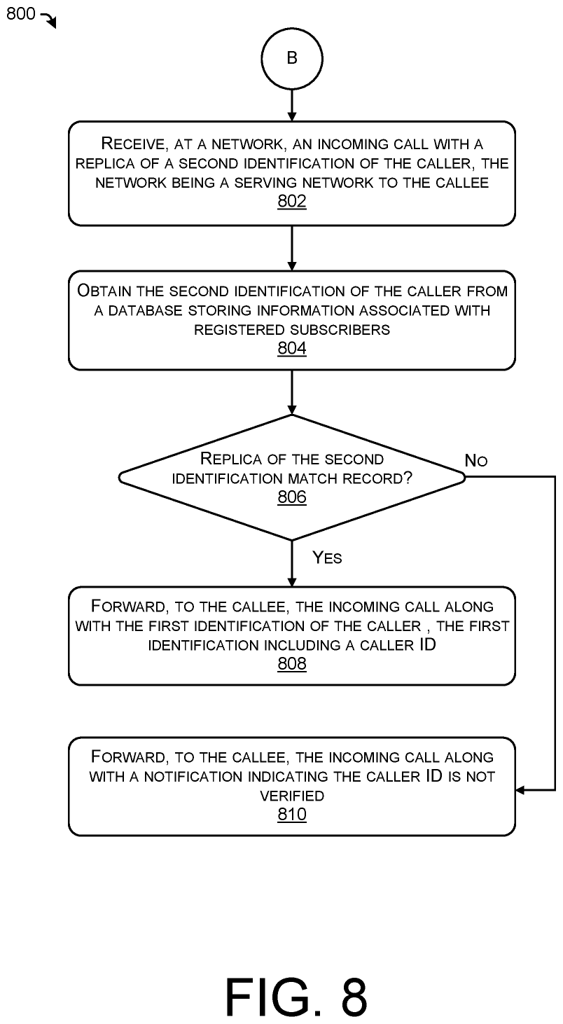

If the incoming call is from its own subscriber, at operation 706, the process may include determining whether the network is the serving network to caller. If the network is not the serving network to the callee, the process may continue at example process 800 showing in FIG. 8.

If the network is the serving network to the callee, at operation 708, the process may include retrieving a second identification of the caller from a database storing information associated with registered subscribers based on the first identification, the second identification being a caller identity token (CIT). As discussed herein, the CIT associated with the caller may be registered when the subscription is activated. The CIT data of all subscribers may be stored in a trusted authority or one or more mobile network operators. In some examples, a Replay Protection Memory Block (RPMB) scheme may be implemented in CIT data storage.

At operation 710, the process may include forwarding the incoming call to the next hop network. As discussed herein, the incoming call may be forwarded to the next hop network along with the caller ID and the CIT data of the caller. In some examples, TAS of the network may encrypt the CIT data of the caller with a key pair (e.g., a symmetric key pair) and send the encrypted CIT data of the caller to the next hop network.

FIG. 8 illustrates an example process for secure caller ID, according to another example of the present disclosure. Example process 800 describes subsequent process following example process 700, and may be implemented by a telephony application server of a serving network to a callee (e.g., TAS 616 of network 4, as shown in FIG. 6) according to the example described in FIG. 6.

At operation 802, the process may include receiving, at a network, an incoming call with a replica of a second identification of the caller, the network being a serving network to the callee. As described herein, the incoming call includes a first identification of the caller (e.g., the phone number or name of the caller) and a second identification of the caller (e.g., the CIT data of caller). The CIT data of the caller may be encrypted at an TAS of a home network of the caller (e.g., TAS 610 of network 1, as shown in FIG. 6) and the replica of the encrypted CIT data may be forwarded following the call flow to the callee.

At operation 804, the process may include obtaining a second identification of the caller from a database storing information associated with registered subscribers. In some examples, the serving network of the callee may query a database to obtain the CIT data associated the caller that was registered in the database when the subscription of the caller was activated. As an interceptor on attacker (e.g., interceptor 620) may modify the replica of the CIT data, the received CIT data at the serving network of the callee may not be the authenticated CIT.

At operation 806, the process may include determining whether the replica of the second identification matches a record in the database. In some examples, TAS of the serving network (e.g., TAS 616 of network 4) of the callee may decrypt the received replica of CIT of the caller using an internal algorithm to obtain the CIT data of the caller.

If there is no match between the replica of the second identification and the records in the database, at operation 810, the process may include forwarding, to the callee, the incoming call along with a notification indicating the caller ID is not verified. In some examples, at operation 810, the process may include determining whether the caller ID is associated with a potential harmful number or a potential disliked number. If the caller ID can be classified into one of a potential harmful number or a potential disliked number, at operation 810, the process may include forwarding, to the callee, a descriptive string notifying that the caller ID is a potential harmful number or a potential disliked number.

If there is a match between the replica of the second identification and the record in the database, at operation 810, the process may include forwarding, to the callee, the incoming call along with the first identification of the caller, the first identification including a caller ID. The user equipment of the callee may determine whether to pick up the phone call.

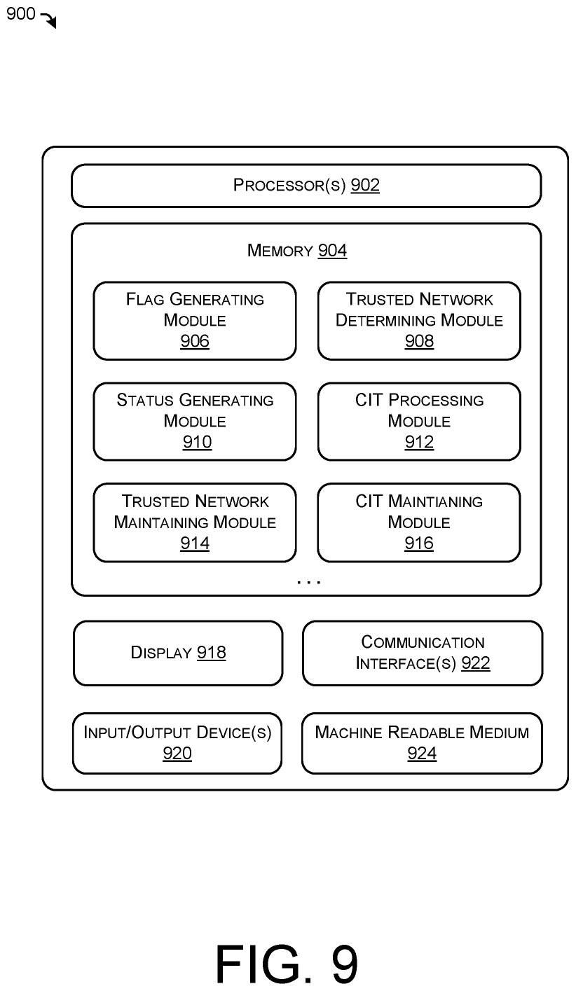

FIG. 9 illustrates an example computer server that implements techniques for secure caller ID, as described herein. The example computer server 900 may be implemented on a telephony application server of a network (e.g., TAS 110, TAS 112, TAS 114, and TAS 116, as illustrated in FIG. 1, or TAS 610, TAS 612, TAS 614, TAS 616, as illustrated in FIG. 6).

As illustrated in FIG. 9, the computer server 900 may comprise processor(s) 902, a memory 904 storing a flag generating module 906, a trusted network determining module 908, a status generating module 910, a CIT processing module 912, a trusted network maintaining module 914, a CIT maintaining module 916, a display 918, input/output device(s) 920, communication interface(s) 922, and/or a machine readable medium 924.

In various examples, the processor(s) 902 can be a central processing unit (CPU), a graphics processing unit (GPU), or both CPU and GPU, or any other type of processing unit. Each of the one or more processor(s) 902 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 902 may also be responsible for executing all computer applications stored in memory 904, which can be associated with common types of volatile (RAM) and/or nonvolatile (ROM) memory.

In various examples, the memory 904 can include system memory, which may be volatile (such as RAM), non-volatile (such as ROM, flash memory, etc.) or some combination of the two. The memory 904 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computer server 900. Any such non-transitory computer-readable media may be part of the computer server 900.

The flag generating module 906 may be configured to generate a trusted flag or a verified flag when a caller ID of a caller is trustable. The flag may be in a form of numerical representation, character representation, or the combination thereof. In some examples, the flag generating module 906 may encode the flag before sending the flag to the next hop network.

The trusted network determining module 908 may be configured to determine whether an adjacent network that forwards the incoming call is a trusted network. The trusted network determining module 908 may look up an identity of the adjacent network in a list of trusted networks. When there is a match, the trusted network determining module 908 may determine the adjacent network is a trusted network.

The status generating module 910 may be configured to generate a status indicator indicating that the caller ID of the caller cannot be verified or the caller has no caller ID. In some examples, the status generating module 910 may use binary data to indicate that the caller ID of the caller cannot be verified or the caller has no caller ID. In some other examples, the status generating module 910 may use descriptive language to indicate that the caller ID of the caller cannot be verified or the caller has no caller ID. In yet some other examples, the status generating module 910 may generate a descriptive string to indicate the caller ID is associated with a potential harmful number or a potential disliked number.

When implemented on TAS of a home network that serves the caller, the CIT processing module 912 may be configured to retrieve pre-registered CIT data of a caller from a database upon receiving an incoming call from the caller. The CIT processing module 912 may further encrypt the CIT data of the caller using a key pair and send a replica of the encrypted CIT data to an adjacent network. When implemented on TAS of a serving network of the callee, the CIT processing module 912 of TAS of the serving network may decrypt the replica of the encrypted CIT data and compare it with the pre-registered CIT data of all subscribers. If there is a match between the decrypted CIT data and a pre-registered CIT, the CIT processing module 912 may determine that the caller ID can be verified and therefore, is trustable.

The trusted network maintaining module 914 may be configured to update a list of the trusted network periodically based on the operations/performance of the networks on the list such as changing a label of a network from trustable to not trustable, removing a network that becomes not trustable. In some examples, the trusted network maintaining module 914 may be configured to add new trustable networks to the list.

The CIT maintaining module 916 may be configured to update CIT data of the network subscribers in real-time and/or periodically. When a subscription is newly activated at the network, CIT data associated with the subscriber and his/her equipment may be registered at a CIT database. In some examples, newly registered CIT data for new subscribers may be uploaded to the CIT database at a preset schedule.

The communication interface(s) 922 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the communication interface(s) 922 can be compatible with multiple radio access technologies, such as 5G radio access technologies and 4G/LTE radio access technologies. Accordingly, the communication interfaces 922 can allow the computer server 900 to connect to the 5G system described herein.

Display 918 can be a liquid crystal display or any other type of display commonly used in the computer server 900. For example, display 918 may be a touch-sensitive display screen and can then also act as an input device or keypad, such as for providing a soft-key keyboard, navigation buttons, or any other type of input. Input/output device(s) 920 can include any sort of output devices known in the art, such as display 918, speakers, a vibrating mechanism, and/or a tactile feedback mechanism. Input/output device(s) 920 can also include ports for one or more peripheral devices, such as headphones, peripheral speakers, and/or a peripheral display. Input/output device(s) 920 can include any sort of input devices known in the art. For example, input/output device(s) 920 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 924 can store one or more sets of instructions, such as software or firmware, which embodies any one or more of the methodologies or functions described herein. The instructions can also reside, completely or at least partially, within the memory 904, processor(s) 902, and/or communication interface(s) 922 during execution thereof by the computer server 900. The memory 904 and the processor(s) 902 also can constitute machine readable media 924.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, are not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system for securing subscriber identification, the system comprising:
one or more processors;
a non-transitory computer-readable memory storing computer-executable instructions that, when executed by the one or more processors, cause the system to:
receive, at a first network, a request from a caller to establish a communication with a callee, the request including a first identification of the caller;
retrieve, by the first network and using the first identification, a second identification of the caller from a database storing information associated with registered subscribers of the first network;
send, by the first network, the request and a replica of the second identification to a second network associated with the callee; and
determine, by the second network and based at least in part on the replica of the second identification, that the caller is a verified caller.

2. The system of claim 1, wherein the computer-executable instructions that, when executed by the one or more processors, further cause the system to:
retrieve, by the second network and using the first identification, the second identification of the caller from the database; and
determine, by the second network, whether the replica of the second identification matches the second identification.

3. The system of claim 2, wherein the computer-executable instructions that, when executed by the one or more processors, further cause the system to:
in response to the replica of the second identification matches the second identification, present, by the second network, the first identification on an interface of a user equipment associated with the callee; and
in response to the replica of the second identification does not match the second identification, present, by the second network, a notification on the interface, the notification indicative of the caller being not verified.

4. The system of claim 1, wherein identifications associated with the registered subscribers of the first network stored in the database are configured to be accessible by a plurality of mobile network operators including the second network.

5. The system of claim 1, wherein the computer-executable instructions that, when executed by the one or more processors, further cause the system to:
send, by the first network, the request and the replica of the second identification to the second network through at least one third network,
wherein the at least one third network is configured to forward the replica of the second identification to the second network without authenticating the replica of the second identification.

6. The system of claim 1, wherein
the first identification of the caller includes at least one of a phone number or a name, and
the second identification of the caller includes at least a caller identity token (CIT).

7. The system of claim 6, wherein the CIT is generated based at least in part on a user equipment associated with the caller when a subscription of the caller to the first network is activated.

8. A system for securing subscriber identification, the system comprising:
one or more processors;
a non-transitory computer-readable memory storing computer-executable instructions that, when executed by the one or more processors, cause the system to:
receive, at a first network, a request from a caller to establish a communication with a callee, the request including an identification of the caller;
verify, by the first network and based on the identification, that the caller is a registered subscriber of the first network;
generate, by the first network, a flag associated with the identification of the caller, the flag indicative of the caller being verified; and
send, by the first network, the request and a replica of the flag to a next hop entity until the next hop entity is the callee.

9. The system of claim 8, wherein the computer-executable instructions that, when executed by the one or more processors, further cause the system to:
query, by the first network and using the identification, a database storing information associated with registered subscribers of the first network; and
determine, by the first network and based on the identification matching a record in the database, that the caller is the registered subscriber of the first network.

10. The system of claim 8, wherein the next hop entity is a second network, the computer-executable instructions that, when executed by the one or more processors, further cause the system to:
query, by the second network, a database storing information associated with trusted networks; and
determine, by the second network and based on the information, whether the first network is trusted.

11. The system of claim 10, wherein the computer-executable instructions that, when executed by the one or more processors, further cause the system to:
in response to the first network being trusted by the second network, send, by the second network, the replica of the flag to a subsequent next hop entity; or
in response to the network being not trusted by the second network, send, by the second network, a status to the subsequent next hop entity, the status indicative of the caller being not verified.

12. The system of claim 8, wherein the next hop entity is the callee, the computer-executable instructions that, when executed by the one or more processors, further cause the system to:
query, by the callee, a database storing information associated with trusted networks; and
determine, by the callee and based on the information, whether the network is trusted.

13. The system of claim 12, wherein the computer-executable instructions that, when executed by the one or more processors, further cause the system to:
in response to the network being trusted by the callee, present the identification of the caller on an interface of a user equipment associated with the callee; or
in response to the network being not trusted by the callee, present a notification on the interface of the user equipment associated with the callee, the notification indicative of the caller being not verified.

14. A method implemented by a system, the method comprising:
receiving, at a first network of the system, a request from a caller to establish a communication with a callee, the request including a first identification of the caller;
retrieving, by the first network and using the first identification, a second identification of the caller from a database storing information associated with registered subscribers of the first network;
sending, by the first network, the request and a replica of the second identification to a second network of the system, the second network being associated with the callee; and
determining, by the second network and based at least in part on the replica of the second identification, that the caller is a verified caller.

15. The method of claim 14, further comprising:
retrieving, by the second network and using the first identification, the second identification of the caller from the database; and
determining, by the second network, whether the replica of the second identification matches the second identification.

16. The method of claim 15, further comprising:
in response to the replica of the second identification matches the second identification, presenting, by the second network, the first identification on an interface of a user equipment associated with the callee; and
in response to the replica of the second identification does not match the second identification, presenting, by the second network, a notification on the interface, the notification indicative of the caller being not verified.

17. The method of claim 14, wherein identifications associated with the registered subscribers of the first network stored in the database are configured to be accessible by a plurality of mobile network operators including the second network.

18. The method of claim 14, further comprising:
sending, by the first network, the request and the replica of the second identification to the second network through at least one third network,
wherein the at least one third network is configured to forward the replica of the second identification to the second network without authenticating the replica of the second identification.

19. The method of claim 14, wherein
the first identification of the caller includes at least one of a phone number or a name, and
the second identification of the caller includes at least a caller identity token (CIT).

20. The method of claim 19, wherein the CIT is generated based at least in part on a user equipment associated with the caller when a subscription of the caller to the first network is activated.
